(19) United States
(12) Patent Application Publication
(10) Pub. No.: US 2007/0011224 A1
(43) Pub. Date: Jan. 11, 2007

(54) Real-time Internet data mining system and method for aggregating, routing, enhancing, preparing, and analyzing web databases

(76) Inventor: Jesus Mena, Alameda, CA (US)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 11/519,360

(22) Filed: Sep. 12, 2006

Related U.S. Application Data
(63) Continuation of application No. 09/645,660, filed on Aug. 24, 2000.
Application No. 09/645,660 is a continuation-in-part of application No. 09/426,107, filed on Oct. 22, 1999, now abandoned.

(51) Int. Cl. G06F 15/16

(52) U.S. Cl. 709/200

(57) ABSTRACT

A real-time Internet data mining system comprising a database, data processing, clustering, segmentation, and classification algorithms, and a networking server. The system receives customer account data from subscriber servers and prepares it for analysis. The data is transmitted to third-party data depositories. The third-parties append selected consumer behavioral information matched by a key, such as a physical or an e-mail address. The appended information is returned to the data mining system where multiple algorithms analyze the accounts based on a desired prediction. The scored accounts and analyses are returned to the originating subscriber servers for use in marketing communications.

### CROSS-REFERENCES TO RELATED APPLICATIONS

This application is a continuation-in-part of application Ser. No. 09/426,107, filed Oct. 22, 1999, which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to a system and method for identifying what products and offers to make available to visitors to on-line stores, such as web sites. More particularly, the present invention relates to a system and method for dynamically scoring on-line transactions via the Internet using customer-provided information as well as demographic information form third-party sources.

Increasingly the first point of contact between a customer and a company is at their website—where a staggering amount of consumer data can be collected and mined. The Internet provides companies an unprecedented opportunity to capture, aggregate, segment and model their customers' behavior and preferences. These interactions reveal important trends and patterns that can help a company design a website that effectively communicates and markets its products and services.

One use of these types of analyses is to stratify e-mail offers to prospects that have been identified by the data mining system. Companies may use this targeted e-mail to provide incentives only to those individuals likely to be interested in specific products and services. Companies would like to reply, route, manage and segment their e-mail in such a manner so that they can efficiently and effectively respond to their customers via highly targeted marketing campaigns.

It is of paramount importance that electronic retailers in a networked economy such as the Internet be adaptive and receptive to the needs of their customers. In this expansive, competitive, and volatile environment web mining will be a critical process impacting every retailer's long-term success, where failure to quickly react, adapt, and evolve can translate into customer “churn” with the click of a mouse.

It is desirable for e-commerce sites, content providers and web-to-wireless services to position their incentives, advertisements, coupons and offers only to those prospects most likely to want specific products and services based on observed prior purchasing patterns.

Current web data analysis systems concentrate their processes at their server level. U.S. Pat. No. 5,950,173 to Perkowski (1999) is typical of a server-specific data mining application. Some data analysis systems have the capability of doing segmentation and prediction at the server level in real time; see, for example, U.S. Pat. Nos. 5,943,667 (1999) and 5,920,855 (1999) both to Aggarwal, et al. These systems are limited to doing their analysis using only server specific data. Their analyses are limited to modeling click-through behavior only. These systems use only the data residing at their machine-specific drives or location.

Some of the known advertising and collaborative filtering network systems use the Internet to match and position products and banners to customers in real-time; see, for example, U.S. Pat. Nos. 5,892,909 (1999) to Grasso, et al., and 5,870,559 (1999) to Leshem, et al. These systems perform some matching of consumer behavior in real time, however they are not performing real time clustering, segmentation, or classification and they are not using third party information from networked data depositories.

There are known applications of autonomous machine learning for electronic commerce, such as U.S. Pat. Nos. 5,832,482 (1998) and 5,781,698 (1997) both to Yu, et al. Data mining tools applications and methods have the capability to connect to remote servers for parallel analysis, such as disclosed in U.S. Pat. Nos. 5,758,147 (1998) to Chen, et al., and 5,727,129 (1998) to Barrett, et al. However there are no current applications for networking via the Internet to third party depositories for the matching and appendage of consumer information.

Internet data mining is also discussed in “Data Mining Your Website” by Jesus Mena, 368 pages (Jul. 15, 1999) Digital Press; ISBN: 1555582222.

There are no existing data mining systems or methods for networking and analyzing data simultaneously via the Internet in real-time. There is no system which combines data mining analysis and networking via the Internet to perform data appends and deliver its results via the Web.

There is thus a need for a data mining system that uses the Internet to retrieve, route, prepare, enhance, analyze and distribute results in real-time. Preferably, the system should process data from subscribed servers, prepare it for analysis, transmit it to third party demographic and webographic data enhancers, retrieve it, and perform multiple inductive data analyses for subscribers to use in e-mail and wireless marketing campaigns.

### BRIEF SUMMARY OF THE INVENTION

It is an object of the present invention solve the problems with existing data mining applications.

It is another object of the present invention to provide a data mining system to deliver models on-demand to subscriber servers.

It is another object of the present invention to provide a data mining system and method which does not use only server-specific data.

It is another object of the present invention to provide a data mining system and method which is not limited to modeling click-through behavior.

It is another object of the present invention to provide a data mining system and method which does not use only the data residing at a specific location or on a specific computer.

It is another object of the present invention to provide a data mining system and method which performs real-time clustering, segmentation, and classification across a network.

It is another object of the present invention to provide a data mining system and method which uses third-party information from networked data depositories.

It is another object of the present invention to provide a data mining system and method which is not server-specific.

It is another object of the present invention to provide a data mining system and method that may be implemented across servers on a network to retrieve, route, prepare, enhance, analyze and distribute results in real-time.

The above and other objects are achieved by a real-time Internet data mining system and method that processes data from subscribed servers, prepares it for analysis, transmits it to third party demographic and webographic data enhancers, retrieves it, and performs multiple inductive data analyses for subscribers to use in e-mail and wireless marketing campaigns.

The system use collects data from subscribers, appends demographics from third-party data providers, and delivers back to subscribers dynamically scored pages in real-time. As customer interact with subscriber sites, ZIP codes, physical address, E-mail addresses, or other demograpaphic keys are routed to the system. The system uses dynamic models to cascade a set of propensity-to-purchase scored pages associated with customer e-mail addresses, or other keys. The subscriber sites can use the scored pages to personalize their marketing incentives and offers, such as offering certain products and/or prices only to those individuals likely to want to purchase targeted products and services. Subscribers to the system benefit from offline demographics and data mining analyses to target their offers and incentives without having to purchase and maintain any data mining software.

### BRIEF DESCRIPTION OF THE DRAWINGS

The invention is illustrated in the figures of the accompanying drawings which are meant to be exemplary and not limiting, in which like references refer to like or corresponding parts, and in which:

FIG. 1 is a block diagram of a preferred embodiment of the web data mining system according to the present invention;

FIG. 2 is a block diagram illustrating the flow of information from the subscriber servers to the data mining system of FIG. 1;

FIG. 3 is a table illustrating the types of data a subscriber server may provide to the data mining system of a preferred embodiment of the present invention;

FIG. 4 is a block diagram illustrating the transmission of an identification key from the data mining system to third party depositories according to a preferred embodiment of the present invention;

FIG. 5 is a table illustrating the type of key routed to third party depositories for matching and data appending according to a preferred embodiment of the present invention;

FIG. 6 is a block diagram illustrating the return of appended information from the third party depositories to the data mining system of a preferred embodiment of the present invention;

FIG. 7 is a table illustrating the type of information that may be appended by third party data depositories in a preferred embodiment of the present invention;

FIG. 8 is a block diagram illustrating the transmission of a predictive score from the data mining system to the subscriber servers of a preferred embodiment of the present invention; and

FIG. 9 is a table illustrating the type of scores that a preferred embodiment of the present invention may provide to the subscriber servers.

### DETAILED DESCRIPTION OF THE PREFERRED EMBODIMENTS

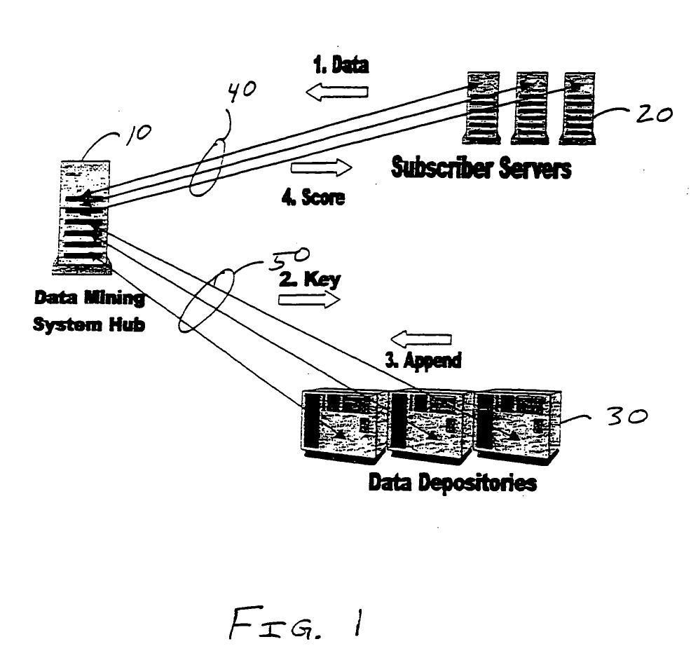

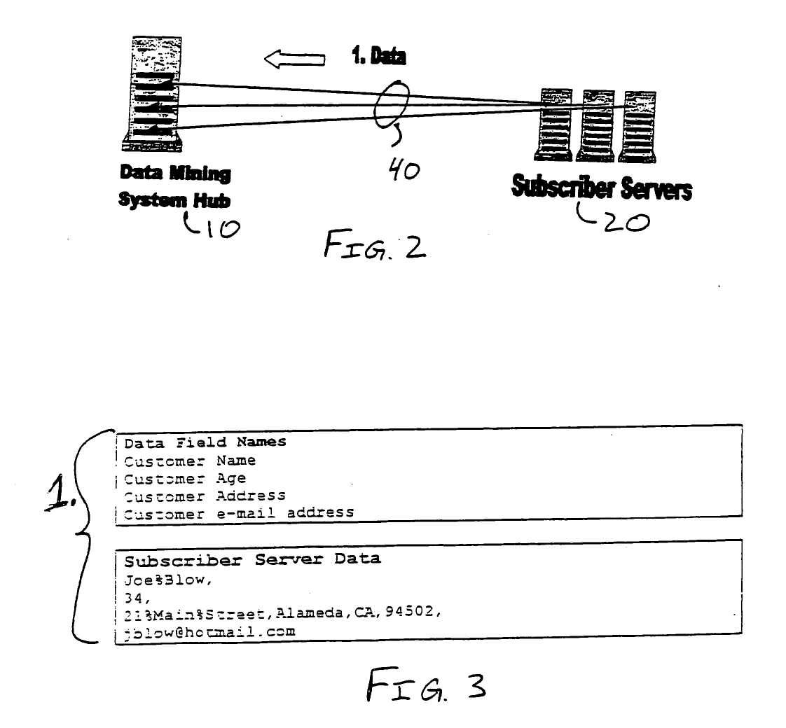

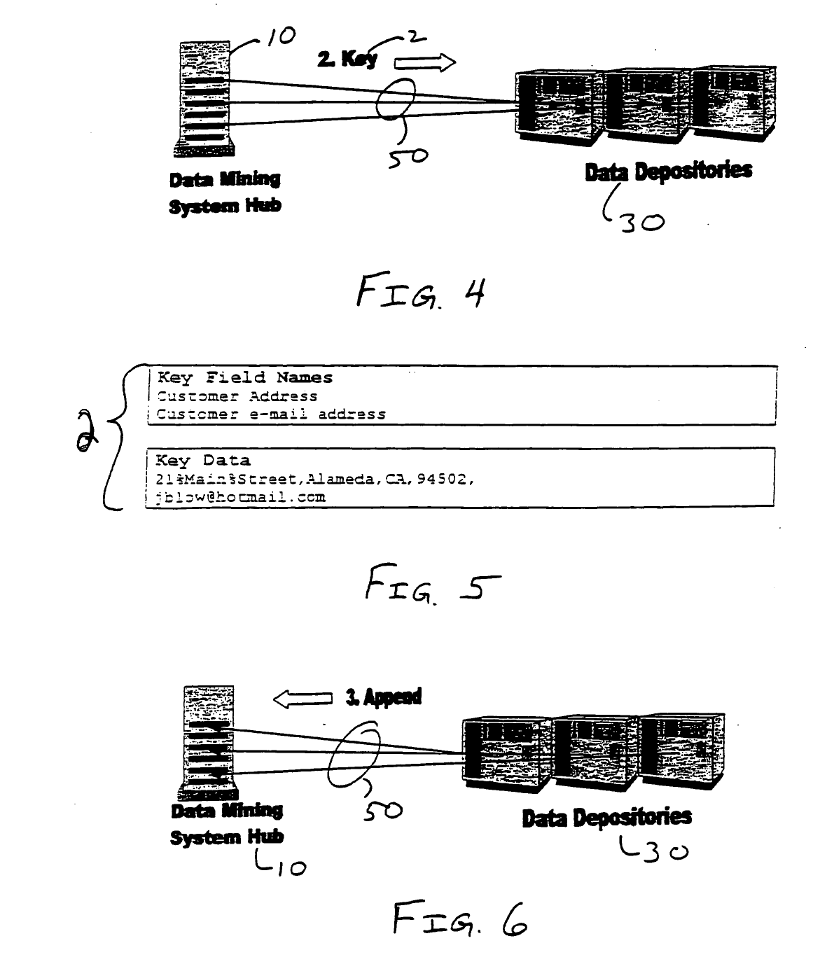

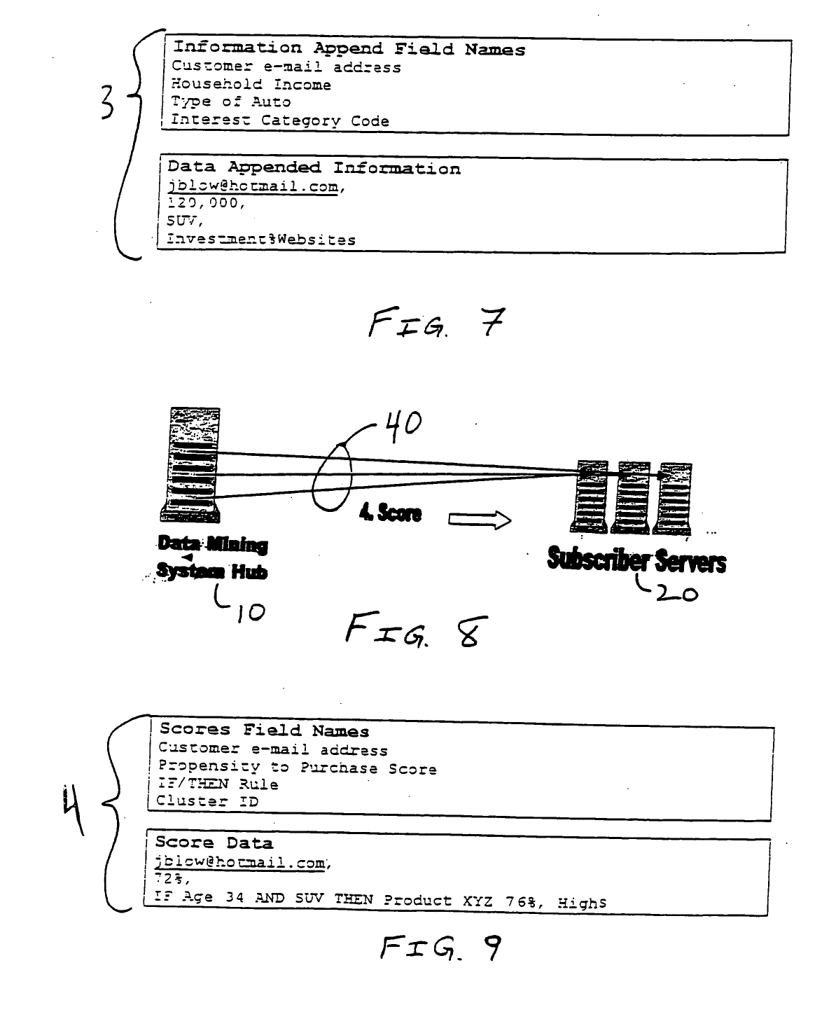

With reference to FIGS. 1-9, a preferred embodiment of the system of the present invention comprises a computer 10 connected to a network 40, 50, such as the Internet, to 1) observe human interaction at remote subscriber web server sites 20, collecting clickstream and visitor provided information from them and 2) match it with third party demographic databases 30 for purposes of 3) generating predictive scores and/or dynamic web pages for customer propensity to purchase, product cross and up selling, fraud detection, visitor lifetime valuation, customer profitability rating, and customer (churn) attrition. The present invention comprises a method of incorporating data mining models through the Internet 40, 50; aggregating transactional data, appending demographics to it, scoring it and transmitting behavioral scores 4 to subscriber e-retailer and content provider web server sites 20.

The present invention is a web data mining system for use with a large, publicly accessible network 40, 50, such as the Internet. Operating as a service, subscriber servers 20 transmit their web data to the system 10 which returns to them their customer accounts segmented, prioritized and scored ready for same-day targeted messaging. The system automates the process of 1) preparing web data for analysis, 2) transmitting it to remote data depositories for matching appends 30, 3) analyzing the enhanced data via clustering, segmentation and modeling algorithms and 4) routing the results of the analyzes back to the subscriber servers 20.

The web data mining system leverages the networking of subscriber servers 20 and remote third party data depositories 30 for the appendage of consumer behavioral information to subscriber servers' customer accounts. Similarly it will use the Internet 40, 50 to retrieve, route and return analyzed account information to subscriber servers.

The invention comprises a modularized modeling Internet data mining system, incorporating multiple algorithms for customized data analyses, allowing it to provide outputs in the desired formats of its subscriber servers 20. Using multiple data mining technologies the system provides to its subscriber servers IF/THEN rules, predictive scores, decision trees, graphical clusters, etc.

The system provides data analyses of web data to the subscriber servers 20 for target marketing, customer profiling and segmentation, decision support, market basket analysis, product affinities, cross and up selling, fraud detection, credit validation, etc. The system provides an on-demand web data mining service for e-commerce sites, content providers and web-to-wireless services. Member websites do not need to purchase any software or hire additional staff, they instead transmit their web data to the data mining system hub 10 which returns to them their customer accounts segmented, prioritized, scored, and ready for same day processing and messaging.

The system assists subscriber servers 20 in the consolidation, preparation, enhancement, mining and leveraging of their web data. The web data mining system ensures that the web data is created, prepared, enhanced, analyzed, and delivered.

Templates are provided to subscriber servers 20 to ensure adequate customer and transactional information is being captured. Through the strategic use of registration and purchase forms, the servers 20 capture important personal identification information as well as important data fields for subsequent information appends—matching attributes such as ZIP code, physical or e-mail addresses.

The system ensures that subscriber server 20 web data is correctly prepared for data analysis by performing multiple pre-processing routines for the ‘smoothing’ of the data. Multiple routines are run in order to convert transactional data into a format suitable for mining.

The system hub 10 routes the key customer identifiers, such as a physical or e-mail address in real-time to external consumer, household, demographic and webographic third party data depositories 30 for multiple data appends. The third party data providers 30 will return matched customer attributes to the data mining system hub 10 in real time.

The system performs multiple analyses of subscriber-enhanced web data using state-of-the art pattern recognition algorithms for the generation of graphical decision trees, IF/THEN rules, self-organizing maps, predictive behavioral scores, etc. Because of the modular design of the system only the analyses requested by the subscriber servers will be performed, allowing for the customized delivery of the desired formats.

The system provides to its subscriber servers 20 the results of the desired multiple analyses in actionable formats 4 that can be used for e-mailing and wireless communications for targeted marketing and customer attraction and retention. The results of the analyses are delivered in same-day or real-time; depending on the desired application of the subscriber servers 20.

As shown in FIG. 1, in a preferred embodiment raw data 1 comprising information about a website's users is routed from the subscriber servers 20 to the system hub 10 over communications link 40, such as the Internet.

After system hub 10 receives the data 1 from subscriber servers 20, it routes a matching key 2, such as a ZIP code, a Social Security number, an e-mail or a physical address, to third-party data demographic and webographic depositories 30 via communications link 50, such as the Internet.

The depositories 30 return to the system hub 10 appended information 3 via communications link 50.

At the system hub 10, the appended information 3 is clustered, segmented, and classified, and predictive scores 4 are sent by the system hub 10 to the subscriber servers 20 via communications link 40. In a preferred embodiment, the predictive scores 4 are used by the subscriber servers 20 for real-time marketing communications.

Every visitor action at a website, such as those websites residing at subscriber servers 20, is a digital gesture exhibiting habits, preferences and tendencies. These interactions reveal important trends and patterns that can help a company design a website that effectively communicates and markets its products and services. Companies can aggregate, enhance and mine web data in order to learn what sells, what works and what doesn't, who is buying and who is not. Every company can have a website which can be used to create consumer interactions that can drive its marketing and communications with its clients.

The system routes, enhances, prepares and distributes web data analyses to subscriber servers 20 so they can effectively communicate with potential customers via e-mail or wireless formats. The real-time Internet data mining system is designed to provide models via a unique networked fluid framework to subscriber servers 20. The system is designed to coherently integrate data components from multiple sources 30, as well as to automate the process of data preparation and modeling in real-time for electronic commerce websites.

There are several data components that web servers, such as subscriber servers 20, are able to generate which provide some insight about consumers and visitors; they include log and cookie files and databases created from Common Gateway Interface (CGI) forms. Server log files provide domain types, time of access, keywords, and search engine used by visitors and can provide some insight into how visitors and customers arrived at a website and what keywords they used to locate it. Log server files identify where visitors come from and what they were looking for.

Special HTTP headers, known as “cookies”, dispensed from a server, such as subscriber server 20, can track browser visits and pages viewed and can provide some insight into how often a visitor has been to the site and what sections they wander into. Cookie headers identify returning visitors and where they go while at a web site. Cookies are a common mechanism used by e-commerce sites for tracking new visitors and repeat customers. They provide some level of customization by identifying returning browsers to the servers that have issued cookies.

Internet CGI forms can provide important visitor and customer provided personal information, such as gender, age, and ZIP code. Forms identify who visitors or customers are by passing the information they input to a database, such as data depositories 30. This is probably the most important customer view since it contains information that can be used to append additional data. For example, a physical address can be used to match and append consumer household information such as estimated income. An e-mail address on the other hand can be used to match and append an online profile, such as content preference from an ad or collaborative filtering network.

Since every visit to a website signals a consumer's interest in a product or service, it is vital that every interaction be captured by subscriber servers 20 and forwarded to the data mining system hub 10. In preparation of any analysis it is critical to first assemble the divergent data components into a cohesive, integrated and comprehensive view of visitors and customers. A preferred embodiment of the invention uses a set of templates to assist subscriber servers 20 in organizing their web data 1 prior to transmitting it to the processing system hub 10.

One key to compiling and capturing consumer information is the assignment of a unique identifier: a visitor identification number. A proven strategy is having visitors register initially at the site by enticing them with a special service or incentive, such as a contest or door prize. Upon registration a “cookie” header can be set and a unique identification number (key) 2 can be assigned to a customer, which enables a subscriber server 20 to track every interaction with that visitor. The unique key also allows the site to link log files and forms database and e-mails which can then be transmitted to the system hub 10 for pre-processing and uploading for matching with third party demographic and webographic data depositories 30.

In a preferred embodiment of the present invention, the customer created data 1 is transmitted to the data mining system hub 10 via a Java servlet installed on one or more HTTP (web) servers 20 that are part of the subscriber server's Internet domain. Java servlets are supported by many HTTP servers and operating systems and can work with the subscriber server 20 on any integration issues that arise. A Java servlet can communicate with the data mining system servers 10 via HTTP. In a preferred embodiment, all data transmitted between the data mining system hub 10 and the subscriber server's site 20 is encrypted with the DES algorithm. The Java servlet communicates with the subscriber server 20 via HTTP.

The system evaluates the subscriber servers' data structure in order to determine the best type of analysis process to use. In a preferred embodiment, prior to analysis the system runs a routine to evaluate the ratio of categorical/binary attributes in the data set, the nature and structure of the data, and the overall condition and the distribution of the data.

As a general rule, neural networks work best on data sets with a large number of numeric attributes. Machine-learning algorithms incorporated in most decision tree and rule-generating data mining tools work best with data sets with a large number of records and a large number of attributes. Empirical studies have shown that the structure of the data critically impacts the accuracy of a data mining tool. For example, data sets with extreme distributions (skew>1 and kurtosis>7) and with many binary/categorical attributes (>38%) tend to favor machine-learning based data mining tools.

The system performs additional data preparation processes to prepare the web data from subscriber servers 20. This ensures that the system models are optimized to achieve the maximum accuracy. Transactional data commonly must be transformed into a format suitable for data mining. For example, missing or empty values present a problem. What value, if any, should be used for a field in which a value is missing? One answer is to simply ignore such records. As a practical rule, low density variables, such as customer record fields with density of less than 5%, contribute little information and in a preferred embodiment, a program is run to remove them from any analysis.

Another routine that is used in a preferred embodiment of the present invention is one involved in uniformly randomly selecting a subset of a data set for analysis. A portion of the pseudo C code for the program to process the data is shown below in Table 1:

TABLE 1
/* randomgenerator.c This routine will produce uniformly distributed
random numbers */
/*

| | |
|---|---|
| * | pseed is long random number between 0 and 0x7fffffff |
| * | rseed is unsigned long random number between 0 and |
| | 0xffffffff |
| * | random and rand32 are floats between 0.0 and 1.0 |
| * | setseed sets the seed from the internal clock |

*/
#include “dp.h”

| | |
|---|---|
| #define N | 31 |
| #define M | 3 |
| #define NM | N-M |

#define L_MASK 0x7fffffff
#define L_NORM 2147483647.e0

| | |
|---|---|
| #define RANTABDIM | 29 |

| | |
|---|---|
| static unsigned long | rantab [RANTABDIM*RANTABDIM]; |
| static long | rantabset=0 |

| double random1 ( | | // return random double (0., 1.) |
|---|---|---|
| | unsidnd long *pseed) | // from lookup table |

{

| | |
|---|---|
| long | i; |

| | unsigned long seed; |
|---|---|
| | seed = *pseed; |
| if | ( ! rantabset) ( // populate rantab |
| | for (i=0; i<RANTABDIM*RANTABDIM; i++) ( |
| | seed = seed \hat{ }(seed >> M); |
| | seed = L_MASK & (seed \hat{ }(seed << NM)); |
| | rantab[i] = seed; |
| | } |
| | rantabset = 1; |

}

// find lookup value

seed = seed \hat{ }(seed >> M);
seed = L_MASK & (seed \hat{ }(seed << NM));
i = (seed % RANTABDIM) * RANTABDIM;
seed = seed \hat{ }(seed >> M);
seed = L_MASK & (seed \hat{ }(seed << NM));
i += seed % RANTABDIM;
*pseed = rantab[i];

// replace lookup value

seed = seed \hat{ }(seed >> M);
seed = L_MASK & (seed \hat{ }(seed << NM));
rantab[i] = seed;
return (*pseed/L_NORM);

}

| | |
|---|---|
| double random ( | // return random double (0.,1.) |

unsigned long *pseed)

{

*pseed = *pseed \hat{ }(*pseed >> M);
*pseed = L_MASK & (*pseed \hat{ }(*pseed << NM));
return (*pseed/L_NORM);

}

| | |
|---|---|
| unsigned long random32( | // return random double (0.,1.) |

unsigned long *pseed)

{

*pseed = *pseed \hat{ }(*pseed >>M);
*pseed = L_MASK & (*pseed \hat{ }(*pseed << NM));
return *pseed;

}

| | |
|---|---|
| double ran32 ( | // return random with triangular |
| distribution (0.,1.) | |

unsigned long *rseed)

{

static unsigned long pseed;
pseed = *rseed;
random (&pseed);
*rseed = pseed & (unsigned long) 0xffff1;
random (&pseed);
*rseed 1 = (pseed & (unsigned long) 0xffff1) << 16;
return (0.5* (*rseed/L_NORM));

}
void setseed(

unsigned long *pseed)

{

long i;
unsigned long 1seed;
time (&1seed);
*pseed − 1seed;
for (i=0; i<100; i++) random (pseed);

}

A problem similar in some respects to missing values is that of variables that are in fact constants; that is, data fields that contain only a single value. These should be removed before any analysis takes place and again, the system runs a program to detect and delete these data fields. The system also detects and extracts random samples of categorical values in the data to ensure any data analyses are accurate and effective.

Often, derived ratios of input fields may be required in order to capture the impact or the true value of the inputs, such as, for example, to capture the velocity of a client value, such as profit or propensity to buy. For example, a common derived ratio is one of debt-to-income, so that rather than using simply the debt and income attributes as inputs, more can be gained by the ratio rather than the individual values. The system provides the flexibility and ability to create ad hoc ratios of the subscribers' web data. For example, since a value such as the number of visits or the number of purchases made over time by that customer may provide a better insight into the true value of those customers, a preferred embodiment of the system allows for several types of automatic transformations, such as the following: (1) number of purchases divided by number of visits, resulting in a Propensity to Purchase Ratio (e.g., 7 purchases/9 visits=0.77 Propensity to Purchase Ratio); and (2) amount of sales divided by number of visits, resulting in a Profit Ratio (e.g., $39 in prior sales/5 visits=7.8 Profit Ratio).

The system supports multiple pre-processing operations in the preparation of the data prior to analysis, including the conversion of categorical fields into 1-of-N values, the normalization of continuous value fields, etc.

The system provides an integrated solution wherein subscriber servers 20 can transmit their customer data 1 to a centralized analysis engine 10. The invention provides a hub 10 that can pre-process the data and transmit it to multiple third party data depositories 30 using predefined formats and protocols. A large percentage of effort in data mining is in the preparation of the data prior to analysis—the system ensures this process is automated through the use of sequential template routines.

In a preferred embodiment of the present invention, a customer provides personal information from CGI forms, such as a ZIP code, a physical address, or an e-mail address, which can be used to append external third-party information This external information can be Linked to the subscribers' web data 1, enabling additional insight into the identity, attributes, lifestyle, and behavior of their visitors and customers. This type of household information is available in real-time from data depositories 30; the invention selectively networks with data depositories 30 based on the desired content they provide. For example, some depositories have superior information penetration in selected demographics or consumer income and personal worth.

In addition, new providers of ‘webographics’ have recently emerged who sell either software or services, and sometimes both, for collaborative filtering, relational marketing, and visitor profiling. These new data providers represent a whole new genre of web companies seeking to capture and generate information about Internet users' behavior and preferences. It includes both proprietary databases as well as advertising and collaborative filtering networks of servers. These providers use a myriad of solutions to track and profile visitors—everything from proprietary software and databases to the commingling of cookie headers via server networks. These data providers sell webographic profiles based on the type of content that visitors view, the time they spend viewing and the frequency of visits to networked websites. Profiles may include identification numbers, interest category codes and interest scores.

The system hub 10 receives the web data 1 from subscriber servers 20, extracts and transmits a key identifier 2 for matching and appending consumer and browsing information from demographic and webographic data depositories 30. This third party information may include, by way of example and not by way of limitation, age, presence of spouse, presence of children, mail order responsive indicator, household income, occupation, phone number, type of vehicle, and other lifestyle data. This third-party information can be appended to website data set, enabling the system to analyze the enhanced data and gain insight into the market segments and tendencies of these customers including their attributes, preferences, as well as online and offline consumer behavior.

Most analyses of web data have typically been limited to the generation of log traffic reports, most of which provide cumulative accounts of server activity but do not provide any true business insight about customer demographics and online behavior. Most of the current traffic analysis systems, such as packet sniffers, provide predefined reports about server activity based on the analysis of log files or meta tags in HTML pages. This basically limits the scope of these type of tools to statistics about domain names, IP addresses, cookies, browsers and other TCP/IP specific machine-to-machine activity.

The present system, however, is geared to use not only TCP/IP activity server data, but also to expand the repertoire of information to include demographics and webographics from third party networked data depositories 30. The mining of web data by the system is geared at discovering the attributes and likely behavior of consumers, rather than the generation of server statistics. Subscriber servers 20 involved in e-commerce need to know about the preferences and lifestyles of their customers. The system provides to its subscriber servers insight about who is buying what items and what other type of products or service are they likely to buy based on their lifestyles.

Subscriber servers 20 would like to know what is selling and to whom so they can adjust their inventory and pricing. More importantly they need to know how to sell and what incentives, offers and ads work, and how they can design their site and their E-mail and wireless communications to optimize their profits. In a networked market environment, the margins and profits go to the quick and responsive players who are able to leverage predictive models to anticipate customer behavior and preferences. The type of analyses provided by the system to its subscriber servers is desirable in order for them to make decision about which clients are the most profitable and what their characteristics are in order to find more customers just like them.

The service the system provides to its subscriber servers 20 involves the gathering of their web data 1, coupled with additional information from third party depositories 30 and analyzing it in real-time using multiple paradigms to discover what products have cross-selling opportunities. Yet another benefit of the service is letting subscriber servers know what information and incentives they should provide to their customers based on their gender, age, demographics, life style and online browsing interests.

The system captures important visitor attributes from its subscriber servers 20, such as their logs and cookie files, or CGI forms databases. Next, the system appends to that web data household, demographic and webographic information 3, such as from data depositories 30. Then, using powerful pattern-recognition technologies, such as neural networks, machine-learning and genetic algorithms, the system hub 10 profiles customers in order to predict their propensity to buy or respond to marketing offers, incentives or coupons. The system provides the results 4 of its multiple analyses to its subscriber servers 20 in actionable formats they can immediately use to their competitive advantage.

The system generates customized data mining solutions, such as association, segmentation, clustering, classification, prediction, visualization, and optimization.

For example, the system incorporates multiple algorithms capable of segmenting web data into unique groups of customers each with specific consumer behavior. The system uses machine learning algorithms to perform autonomous statistical tests on the data in order to partition it into multiple segments independent of the analysts or marketer. These types of algorithms identify key intervals and ranges in the data, which distinguish the good prospect from the bad prospect in marketing communications. One of the outputs from this type of analysis is in the form of conditional IF/THEN rules. For examples, if the system has information about a user's gender (e.g., MALE=1/FEMALE=0), and the user's number of visits to a web site (e.g., 4.00), the system might construct the following IF/THEN rule:

| If FEMALE=0/MAKE=1 is 1 | |
|---|---|
| and NumberOfVisits is 4.00 | |
| Then | |
| TotalSales is more than 215.34 | |
| Rule's probability: 0.694 | |
| The rule exists in 34 records. | |
| Significance Level: Error probability < | 0.001 |

This rule has identified males who have visited this website more than 4 times as good prospects for a high amount of sales.

Similarly, the system might construct a rule based on a user's age and the number of minutes if has been connected to a web site. An example of such an IF/THEN rule might be:

| If Age is 49.00 | |
|---|---|
| and ConnectMinutes is 1.00 ... 3.00 (average = 1.67) | |
| Then | |
| TotalSales is more than 215.34 | |
| Rule's probability: 0.667 | |
| The rule exists in 26 records. | |
| Significance Level: Error probability < | 0.01 |

This rule has identified two conditions impacting a high amount of online sales, the customers' average age (49) and the average connect time (1.67).

Using a machine learning algorithm, the system hub 10 segments the data into unique groups of online visitors and customers, each with individual behavior. The system's algorithm performs statistical tests on the data and partition into multiple market segments independent of the analysts or marketer. The data system algorithm can autonomously identify key intervals and ranges in the data, which distinguish the good from the bad prospect.

The Internet data mining system allows subscriber servers to make some projections about the profitability potential of its visitors in the form of business rules, which can be extracted, directly from the web data. An example might be:

IF search keyword is “PC_software”
AND gender male
AND age 24-29
THEN average projected sale amount is $267.26 <= Low

Another example might include:

IF search keyword is “math_software”
AND search engine YAHOO
AND subdomain .AOL
THEN average projected sale amount is $379.95 <= High

The following rule includes possible data sources 20, 30 which may be used to generate a score 4 for subscriber server 20:

| | |
|---|---|
| IF Income $75,000 | <= SOURCE: Demographic Depository |
| | (Experian) |
| AND gender male | <= SOURCE: Website Subscriber |
| | Registration Form |
| AND ESPN visitor | <= SOURCE: Webographic Ad Network |
| | (DoubleClick) |
| AND bought NFL game | <= SOURCE: Collaborative Filtering |
| | Network (Firefly) |

THEN propensity to purchase Product A: 78%
THEN propensity to purchase Product X: 13% Or,
THEN average projected sale amount is $267.26 <= High

This type of format solution can also be provided as graphical decision trees to subscriber servers 20.

Yet another type of data mining solution is in the form of graphical clusters, which are well-known in the art, such as self-organizing maps or Kohonen neural networks. Preferably, a graphical cluster will identify by color or shading where certain attributes, such as a high probability of sales, occur. The clustering analysis can identify sub-sets in the data representing highly profitable customers. This type of analysis can be used to partition the features of these clusters for subscriber servers to view.

Additionally, a preferred embodiment of the system provides Propensity to Purchase scores 4 for subscriber servers 20 for their products and services. These scores 4 may be constructed using either polynomial or neural networks. In a preferred embodiment, a neural network is used to construct customer behavior models for predicting who will buy and how much they are likely to buy.

As is well-known, the ability to learn is one of the features of neural networks. They are not programmed as much as trained A neural network trains on samples and can construct predictive models for “scoring” visitors' propensities to purchase behavior. Typically, a neural network is “trained” on observations about data relationships for example, “Males 34-39 purchase printers but not scanners.” A neural network can gradually learn to detect this relationship and the features of these types of consumers. Neural networks are basically computing memories where the operations are association and similarity. They can learn when sets of events go together, such as when one product is sold, another is likely to sell as well, based on patterns they observe and are trained by the data mining system over time.

The use of neural networks coupled with genetic algorithms can autonomously extract hidden relationships among web data and thereby determine if patterns exists which can yield actionable business and marketing intelligence. Web data mining goes beyond log analysis and ad clickstreams—it is focused on the identification of customer attributes and their consumer behavior. The goals are generally to find out who is likely to purchase certain products and services and what are the features of the most loyal and profitable customers.

In a preferred embodiment of the present invention, the service is provided on an opt-in basis, thus allowing the individual users and visitors to subscriber servers 20 to decide whether they want their data used by the system. Since the system uses keys, such ZIP codes and physical addresses, to retrieve demographic data, the on-line visitors need not complete lengthy or intrusive registration forms.

A preferred embodiment of the present invention generally involves two phases for implementation. First, during a learning phase the system learns the transactional patterns and demographics of subscriber website online customer. During the learning phase, a subscriber e-retailer, running a subscriber server 20, provides the system a historical sample of customer transactions. Preferably, this takes place over a period of 2 to 3 weeks; subscriber websites 20 simply install a small piece of code that will re-direct certain web data to the system servers 10. The system appends demographics from third-party databases 30 and develops a set of association rules and/or score formulas, which are loaded on the system server hub 10 and matched against new transactions. During this phase the system prepares, enhances, and mines the data and generates the code for its dynamic models. The models will be used to suggest what products and services customers are likely to want to purchase. These models will use both transactional data from the subscriber sites coupled with third party offline ZIP code and household demographics. During this phase, the subscriber site 20 transmits its transactional data to the system hub 10 for a period of several weeks, after which the recommendation phase begins.

After the system learns the patterns and demographics of subscriber servers' online customers, it begins to make recommendations about products and services matched by the association rules and/or score formulas while the users are still at the subscriber website. This real-time phase involves the deployment of the dynamic models in the system servers 20, which collect the subscriber data 1 as new and returning customers complete registration and purchase forms at the web sites of the subscriber servers 20. It continues to append demographics to this web data; however, during this production phase the system begins to return to the subscriber servers dynamic page recommendations 4 in real-time. New transactions are routed to the system hub 10 where an internal matching takes place to determine if a prior profile exists on that customer. If no match is found, a reference key 2, such as a physical address, is transmitted to a third-party database demographer 30 for appendage of household information 3. The demographer 30 routes matched records 3 to the system hub 10 which matches it against a table of association rules and/or a set of score formulas, developed in learning phase, in order to generate a dynamic page (product recommendation) 4 that is transmitted to subscriber server website 20.

Although the invention has been illustrated and described in detail in the drawings and foregoing description, the same is to be considered as illustrative and not restrictive in character—it being understood that only representative embodiments have been shown and described, and that all changes and modifications thereto are within the spirit and scope of the invention are desired to be are desired to be protected. It should be understood that various alternatives to the embodiments of the invention described herein can be employed in practicing the invention. It is intended that the following claims define the scope of the present invention and that structures and methods within the scope of these claims and their equivalents be covered thereby.

What is claimed is:

1. A data mining system comprising:
one or more subscriber servers for collecting information identifying a user and providing a first data set of user information,
one or more demographic databases having third party information relating to targeted market segments and providing a second data set of said third party information relating to targeted market segments; and
a processor in operative communication with the one or more subscriber servers and the one or more demographic databases and receiving said first data set from the one or more subscriber servers and said second data set from the one or more demographic databases,
said processor including a rule processor receiving said first data set and said second data set and applying said first and second data sets to one or more rules to determine a score predicting behavior relating to said collected information identifying said user;
wherein the processor receives the first data set of user information from one of the subscriber servers and generates a unique key corresponding to the collected information identifying a user; and
wherein the one or more subscriber servers are coupled to an Internet; the one or more demographic databases are coupled to the Internet; and the processor is coupled to the Internet.

2. The system according to claim 1 wherein the unique key is a member of the set consisting of an e-mail address, a postal address, a Social Security Number and a TCP/IP address.

3. The system according to claim 1 wherein said rules processor employs pattern recognition technologies selected from the set consisting of neural networks, machine-learning and genetic algorithms.

4. The system according to claim 1 wherein said processor communicates said key to said one or more demographics databases; and
wherein said processor receives appended information associated with said key from said one or more demographics databases.

5. The system according to claim 4 wherein said score is generated by clustering, segmenting and classifying said appended information.

6. The system according to claim 4 wherein said appended information is a member of the set consisting of household information, demographic information and webographic information.

7. A method of mining data, said method comprising the steps of: receiving from one or more subscriber servers user-identifying indicia and providing a first data set of user information;
generating from the user-identifying indicia a key which corresponds to values indexed by one or more demographic databases having third party information relating to targeted market segments;
communicating the key to the one or more demographic databases;
receiving from the one or more demographic databases demographic information relating to the user-identifying indicia and providing a second data set of said third party information relating to targeted market segments;
applying said first and second data sets to one or more rules to determine a score predicting behavior relating to the user-identifying indicia; and
communicating the predictive score to the one or more subscriber servers.

8. A method according to claim 7 further comprising the step of the subscriber server determining whether or not to offer a user a product based on the score.

9. A method according to claim 7 further comprising the step of the subscriber server determining at what price to offer a product to a user based on the score.

10. A method according to claim 7 wherein the score is a propensity to-purchase score indicating statistically a user's propensity to make a purchase.

11. A method according to claim 7 wherein the score is determined using a neural network.

12. A method according to claim 7 wherein said third party information relating to targeted market segments includes household income, gender, age and occupation of the user.
